(19) United States
(12) Patent Application Publication
(10) Pub. No.: US 2008/0163974 A1
(43) Pub. Date: Jul. 10, 2008

(54) METHOD AND APPARATUS FOR ENSURING QUALITY IN STORAGE MEDIA PRODUCTION

(75) Inventors: Bernd Heinz, Buchs (CH); Alois Kegele, Nuziders (AT)

Correspondence Address: PEARNE & GORDON LLP, 1801 EAST 9TH STREET, SUITE 1200, CLEVELAND, OH, 44114-3108, US

(73) Assignee: OC Oerlikon Balzers AG, Balzers (LI)

(21) Appl. No.: 11/970,075

(22) Filed: Jan. 7, 2008

Related U.S. Application Data
(60) Provisional application No. 60/883,860, filed on Jan. 8, 2007.

(51) Int. Cl. B32B 38/10; B32B 43/00

(52) U.S. Cl. 156/64; 156/584

(57) ABSTRACT

A method for manufacturing a storage media comprises the steps of providing two essentially disk-shaped, flat, circular substrate with a first information layer, bonding said substrates together using an adhesive and separating said two bonded substrates again such that at least the adhesive remains with the second substrate. During said separation process the separation force is being measured. A respective apparatus comprises a holding or clamping means (5) for one side of said bonded substrates (3, 5); a fastener (6) for the other side of the bonded substrates; force exerting means via such fastener (6) on said other side of the bonded substrates; and a force measurement device (2) for measuring the separation force acting on the bonded substrates.

This application claims the benefit of U.S. Provisional Patent Application No. 60/883,860 filed on Jan. 8, 2007. Said application is incorporated herein by reference.

### FIELD OF THE INVENTION

This invention concerns optical data storage media, especially in optical disk production, such as Dual Layer Blu Ray Disk (BD DL), DVD-R DL and other multilayer media.

### BACKGROUND OF THE INVENTION

A common method of producing a single sided multilayer optical information carrier, the so called “2P process”, comprises the steps of: forming a first reflecting layer on a substrate; holding a stamper on the first reflecting layer through a liquid radiation curing resin; hardening the resin as to form a transparent layer; peeling off the stamper from the transparent layer; forming a second reflecting layer on the transparent layer; covering the second reflecting layer according to the needs of the specific storage media or forming additional information layers with subsequent process steps.

### RELATED ART

U.S. Pat. No. 5,171,392, U.S. Pat. No. 7,051,347, U.S. Pat. No. 6,117,284 and U.S. Pat. No. 6,309,496 describe general information relating to the 2P process.

In the first step of the 2P process a first substrate with an information layer is produced by injection moulding and coated with a layer material which is appropriate for the format. Then a second substrate is produced with a second information layer. This second substrate is then bonded together with the first substrate using typically an UV-curing adhesive. In the next step the 2 (bonded) substrates are separated whereby the UV resin with the image of the information layer of the second substrate must remain completely at the first substrate. Depending on the application it is also possible to transfer a metallic layer in a similar way from the second to the first substrate.

### PROBLEMS IN THE ART

For a good stamping result and an easy separation, the choice of materials of the UV-curing adhesive and of the second substrate is important. On the other hand, the stamping result can depend significantly on the process parameters. The curing power and time has to be mentioned as the most important factors.

In the process for producing the optical multilayer data storage media as described above, there is the problem that the process parameters which are responsible for the replication quality, (means the almost 1:1 reproduction of each single bit or groove structure in case of recordable and rewritable media) cannot easily be controlled during the production process.

Therefore the measurement of replication quality of the information layer produced by the stamper process is typically done offline for selected disks. Electrical signal measurements on the finished disk are the most direct means to control the replication quality. However, the electrical signal measurement is time consuming and does not allow a prompt feedback to the production process. Other techniques to measure the replication properties like diffraction of light are linked with the same difficulties. Defect scanners, typically used in the optical media production to control each single medium, are not able to quantify the replication quality.

The missing information of the replication quality, continuously measured during the production, can lead to the production of defective or low quality media. On the other hand, the availability of such information would allow optimizing the process parameters in an early stage, either manually or via an automatic feedback loop.

### BRIEF SUMMARY OF THE INVENTION

It is an objective of the present invention to provide a simple technique which extracts information about the replication quality for each single disk during the production process. This information can be used either for manual adjustment of the process parameters or can be used as input signal for an automatic feedback loop.

According to the invention we are proposing a force measurement during the peeling process when separating the stamper disk from the substrate. The measurement of the force during the peeling process gives direct information of the adhering properties of each single pair of stamper and substrate.

### BRIEF DESCRIPTION OF THE DRAWINGS

FIG. 1 shows a force measurement arrangement according to the invention.

FIG. 2 describe the result of a force measurement during peeling.

FIG. 3 shows the dependency of the Jitter from the maximum peeling force.

### DETAILED DESCRIPTION OF THE INVENTION

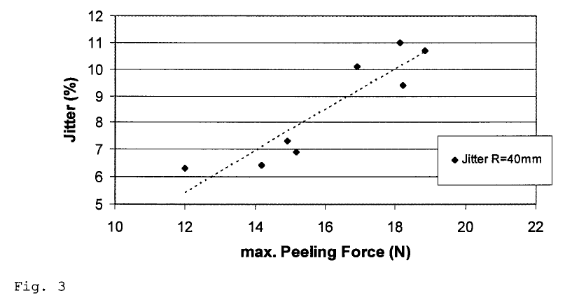

We have shown that there is a reproducible correlation between the separation force when peeling the stamper substrate from the substrate and the replication quality (FIG. 3). Therefore the force measurement gives direct information about the process quality and process stability and allows the re-adjustment of process parameters once the peeling force is out of a specified value. Thereby the quality of the product can be ensured and the danger of producing low quality products is minimized. The need for electrical signal measurements can be reduced.

To measure the peeling force during separation of the stamper disk and the substrate, several possibilities are available. Exemplary, 2 methods are described:

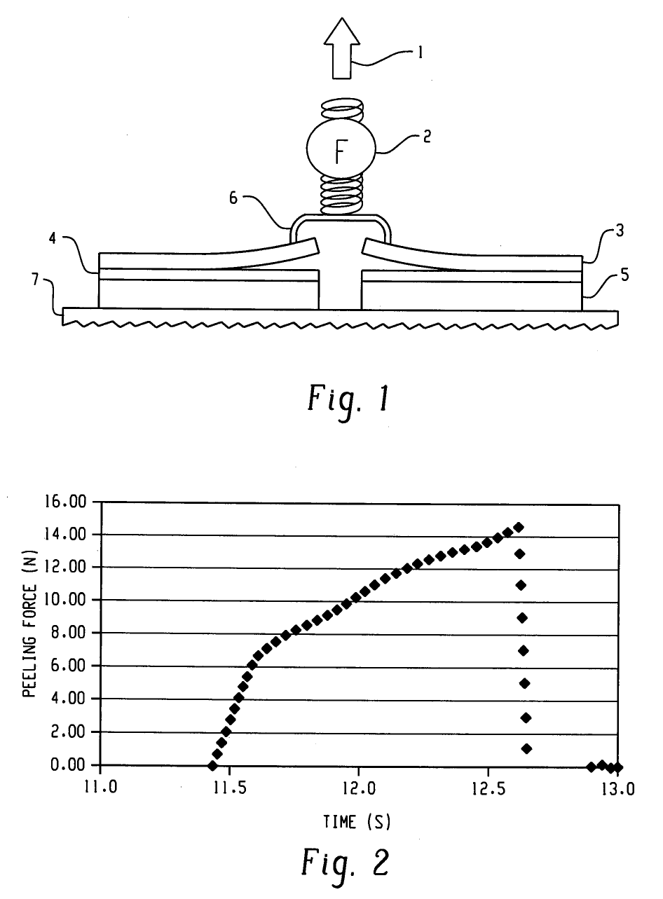

In a first embodiment shown in FIG. 1, there is an extra force measurement unit 2 between the part (fastener 6) which holds the stamper disk 3 and the unit (not shown, effect indicated by arrow for peeling direction 1) which drives the movement to peel the stamper disk 3 and the disk (substrate) 5 apart (FIG. 1). In the given examples (FIG. 2) the force has been measured with the “Zug-Druck-Kraftsensor 8523-50 FNenn=50N, MTS Messtechnik Schaffhausen, Fabr. Burster, USB-Sensor-Interface 9205-V001”.

In a second embodiment the unit for driving the movement for peeling the stamper and the substrate is a servo motor and the peeling force can be extracted using the electrical load of the motor during the peeling process. Other embodiments are possible.

Therefore, in a method for production a storage media, a first substrate with a first information layer is being produced and coated with a layer material. Then a second substrate is produced with a second information layer. Both substrates are essentially disk-shaped, flat, circular and made from a material like plastic (polycarbonate, PMMA or alike). The second substrate is then bonded together with the first substrate using an adhesive. These two bonded substrates are then separated again whereby the resin/adhesive with the image of the information layer of the second substrate must remain completely at the first substrate. Depending on the application it is also possible to transfer a metallic layer in a similar way from the second to the first substrate. The device for separating those bonded substrate (FIG. 1) comprises a holding or clamping means 7 (e. g. a vacuum chuck) for one side of the bonded disk(s) (substrate 5), a fastener 6 for the other side of the disk (substrate 5), force exerting means via such fastener 6 on said other side of the disk and a force measurement device 2 for controlling/measuring the force acting on the bonded disk.

1. Method for manufacturing a storage media comprising the following steps:
Providing a first essentially disk-shaped, flat, circular substrate with a first information layer;
Coating said substrate with a layer material;
Providing a second essentially disk-shaped, flat, circular substrate with a second information layer;
Bonding said first and second substrate together using an adhesive;
separating said two bonded substrates such that at least the adhesive remains with the second substrate;
measuring the separation force during said separation process.

2. Method according to claim 1, wherein said substrates are made from plastic.

3. Method according to claim 1, wherein said layer material is a metallic layer.

4. Apparatus for separating two bonded, essentially disk-shaped, flat, circular substrates comprising:
a holding or clamping means (5) for one side of said bonded substrates (3, 5);
a fastener (6) for the other side of the bonded substrates;
force exerting means via such fastener (6) on said other side of the bonded substrates;
and a force measurement device (2) for measuring the separation force acting on the bonded substrates.

5. An apparatus according to claim 4, wherein said force exerting means is a servo motor.
